(19) United States
(12) Patent Application Publication
(10) Pub. No.: US 2013/0170776 A1
(43) Pub. Date: Jul. 4, 2013

(54) ROLLER BEARING FOR HARD DISK SWING ARM

(71) Applicants: Toru Nanasawa, Kanagawa (JP); Kentarou Sakagami, Kanagawa (JP); Naoto Horiuchi, Kanagawa (JP)

(72) Inventors: Toru Nanasawa, Kanagawa (JP); Kentarou Sakagami, Kanagawa (JP); Naoto Horiuchi, Kanagawa (JP)

(73) Assignee: NSK LTD., Tokyo (JP)

(21) Appl. No.: 13/700,854

(22) PCT Filed: Jul. 24, 2012
(86) PCT No.: PCT/JP2012/068738

§ 371 Date: Nov. 29, 2012

(30) Foreign Application Priority Data
Jul. 27, 2011 (JP) 2011-164758
Jan. 27, 2012 (JP) PCT/JP2012/051848

(51) Int. Cl. G11B 5/48

(52) U.S. Cl. CPC G11B 5/4813
USPC 384/456

(57) ABSTRACT

There is provided a roller bearing for a hard disk swing arm, which is configured to improve the response characteristics of the swing arm by reducing a change in torque hysteresis of a swing arm retaining force with respect to time passage in a HDD drive state. The roller bearing (14, 16) is configured to swing and rotatably support the swing arm provided in a hard disk drive. The roller bearing (14, 16) includes: an inner ring (14a, 16a); an outer ring (14b, 16b); a plurality of rolling elements (14c, 16c) disposed between the inner ring (14a, 16a) and the outer ring (14b, 16b); and a retainer (14d, 16d) that retains the plurality of rolling elements (14c, 16c). The inner ring (14a, 16a) and the outer ring (14b, 16b) have a surface hardness of 700 HV or more and less than 800 HV, and each of the rolling elements has a surface hardness of 945 HV or more and less than 1060 HV.

### TECHNICAL FIELD

The present invention relates to a roller bearing for a hard disk swing arm, and more particularly, to a roller bearing for a hard disk swing arm which has improved response characteristics required for a bearing by suppressing a change in torque hysteresis.

### BACKGROUND ART

FIGS. 3A to 3C illustrate a schematic configuration of an HDD (Hard Disk Drive, also referred to as “HDD” below) as an example. The HDD includes a magnetic disk (hard disk) 2 to record information (data), a spindle motor 4 to rotate the magnetic disk 2, a swing arm 8 as an actuator in which a magnetic head 6 is attached to a distal end portion thereof, and a voice coil 9 which is provided at a proximal end portion of the swing arm 8 and rotates the swing arm 8.

The swing arm 8 is axially supported to be pivotable on a base Bs of the HDD through a pivot bearing unit 10. When rotationally driven by the voice coil 9, the swing arm 8 allows the magnetic head 6 to be displaced (traced) in parallel with respect to the rotary magnetic disk 2. Thereby, it may be possible to read information from the magnetic disk 2 through the magnetic head 6 or write (record) information on the magnetic disk 2 in the HDD.

The pivot bearing unit 10 is provided with a shaft (shaft member) 12 standing on the base Bs of the HDD, a sleeve 18 attached to the swing arm 8, and pivot bearings (roller bearings) 14 and 16 interposed between the shaft 12 and the sleeve 18.

In addition, the respective pivot bearings 14 and 16 are provided with inner rings 14a and 16a and outer rings 14b and 16b as pairs of bearing rings which are disposed to face each other and are able to rotate relative to each other, balls 14c and 16c as a plurality of rolling elements which are rotatably inserted between the respective pairs of bearing rings, and retainers 14d and 16d to rotatably retain the balls 14c and 16c one by one. Then, non-contact shields 14e and 16e as seal members to seal the insides of the bearings are interposed between the bearing rings, thereby preventing foreign matter (for example, dust) from infiltrating from the outside of each bearing and preventing a grease composite enclosed in the inside of the bearing from leaking to the outside of the bearing.

Such pivot bearings 14 and 16 axially and pivotably support the swing arm 8 mounted in the sleeve 18 in a state in which the inner rings 14a and 16a are fitted externally around the shaft 12 and the outer rings 14b and 16b are fitted internally within the sleeve 18. In addition, a ring spacer 20 is fitted to an inner peripheral portion of the sleeve 18 so as to be mutually interposed between the pivot bearings 14 and 16. Thereby, each of the pivot bearings 14 and 16 is positioned and fixed at a predetermined position in a state in which a predetermined pre-load is applied, thereby entering a state of being stable without shaking and pivotable, and enabling the swing arm 8 to have good response characteristics and be smoothly pivoted.

Incidentally, a swing arm to support a data read-out head of an HDD requires positioning performance for quickly and securely reaching a desired track and control performance for acquiring and continuing to hold a desired track on a disk rotating at high speed. Due to the speeding up and high capacity of the HDD, since a demand for such performance increases every year, more accurate positioning and control performance are required. In recent years, the miniaturization and electric power saving of the HDD have advanced rapidly, and thus electric power supplied to a voice coil motor is also made low power and low current in order to drive the read-out head. In addition, considering the development environment of this HDD, it is necessary to increase response characteristics to input signals so that the swing arm may be operated by a required distance within a short time by a smaller force.

The response characteristics of the swing arm are greatly affected by the performance of a pivot bearing unit supporting an arm as the rotation shaft of the swing arm. For example, since a force required for driving the arm is changed by the rotational torque of a bearing, the response characteristics may be improved by a reduction in the rotational torque of the bearing. Patent Document 1 discloses that response characteristics are improved due to the reduction of rotational torque in a minute swing range by setting a rolling element diameter and a retainer pocket diameter.

In addition, Patent Citation 2 discloses that in a ball bearing used for a swing arm, a ball has a surface hardness exceeding 900 HV and preferably of 950 HV or more by applying a metal such as high carbon chromium steel, ceramic, or cemented carbide as the material of the ball, for the purpose of low torque and a change in low torque in addition to the suppression of fretting damage or noise.

Furthermore, Patent Document 3 discloses that in a ball bearing used for a spindle motor of an HDD, the surface hardness of each of inner and outer rings is 720 HV or more, and the surface hardness of a ball is 930 HV or more as well as greater than the surface hardness of each of the inner and outer rings, for the purpose of preventing the generation of fretting wear.

### PRIOR ART DOCUMENTS

### Patent Documents

[Patent Document 1] JP-A-2007-285463
[Patent Document 2] JP-A-11-101250
[Patent Document 3] JP-A-2003-278767

### DISCLOSURE OF INVENTION

### Problem to be solved by the invention

Incidentally, there is a problem in that when the HDD is driven for a predetermined time, a retention force required for the servo control of the swing arm to retain the read-out head at a desired track is changed (attenuated). If the retention force is changed, there is a need to change a servo current. Accordingly, it is preferable that the retention force be always constant. This phenomenon is identified by reciprocating the swing arm at high speed and measuring the retention force of the swing arm at a predetermined interval as the drive test of the HDD. This is considered as being caused by a change in torque hysteresis of the actuator due to the swing thereof at high speed for a predetermined time. However, a specific solution to this problem is currently not known. In addition, the torque hysteresis of the actuator is not disclosed even in any of the Patent Citations.

The present invention has been made in view of the above-mentioned problem, and an object thereof is to provide a roller bearing for a hard disk swing arm capable of achieving an increase in the response characteristics of a swing arm by decreasing a change in torque hysteresis of a swing arm retaining force as time elapses under the drive condition of an HDD.

### Means for solving the problem

The above object of the present invention can be achieved by the following configurations.

(1) A roller bearing for swinging and rotatably supporting a swing arm provided in a hard disk drive, the bearing comprising: an inner ring; an outer ring; a plurality of rolling elements disposed between the inner ring and the outer ring; and a retainer that retains the plurality of balls. The inner ring and the outer ring have a surface hardness of 700 HV or more and less than 800 HV, and each of the rolling elements has a surface hardness of 945 HV or more and less than 1060 HV.

(2) The bearing of claim 1, wherein the inner ring and the outer ring have a surface hardness of 720 HV to 780 HV, and each of the rolling elements has a surface hardness of 945 HV to 1050 HV.

(3) The bearing of claim 1 or 2, wherein each of the inner ring, the outer ring, and the rolling elements is made of any one of stainless steel and SUJ steel.

### Advantageous Effects

In accordance with a roller bearing for a hard disk swing arm, the inner ring and the outer ring have a surface hardness of 700 HV or more and less than 800 HV, and the rolling elements have a surface hardness of 945 HV or more and less than 1060 HV, and thus it may be possible to decrease a change in torque hysteresis of the swing arm retaining force as time elapses under the drive condition of an HDD and enhance the response characteristics of the swing arm.

### BRIEF DESCRIPTION OF DRAWINGS

FIG. 1 is a cross-sectional view illustrating a pivot bearing unit having roller bearings for an HDD swing arm according to an embodiment of the present invention.

FIG. 2 is a graph illustrating a change ratio of hysteresis with respect to time in Conventional Example and Examples 3, 11, and 17.

FIG. 3A is a cross-sectional view schematically illustrating an overall configuration of an HDD, FIG. 3B is a plane view illustrating the overall configuration of the HDD, and FIG. 3C is a half of cross-sectional view illustrating the pivot bearing unit.

### BEST MODE FOR CARRYING OUT THE INVENTION

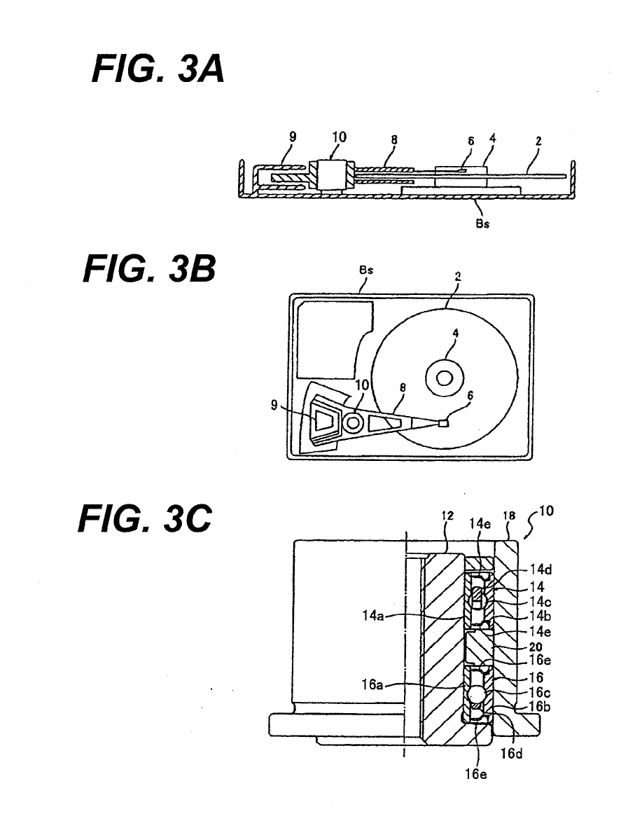

Hereinafter, a roller bearing for a hard disk swing arm according to an embodiment of the present invention will be described with reference to the accompanying drawings. Also, since a schematic configuration of an HDD to which roller bearings of the embodiment are applied is identical to the configuration illustrated in FIGS. 3A to 3C, only a pivot bearing unit will be described herein.

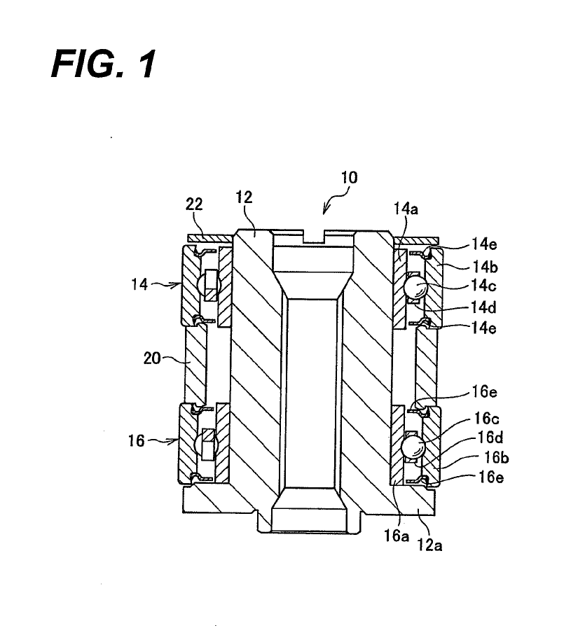

As shown in FIG. 1, the pivot bearing unit 10 includes a shaft member 12 having a flange portion 12a at one end portion thereof in an axial direction, and a pair of roller bearings 14 and 16 disposed in parallel around the shaft member 12.

The pair of roller bearings 14 and 16 includes inner rings 14a and 16a, outer rings 14b and 16b, a plurality of balls (rolling elements) 14c and 16c disposed between the respective inner rings 14a and 16a and the respective outer rings 14b and 16b, retainers 14d and 16d to respectively retain the plural balls 14c and 16d, and non-contact shields 14e and 16e as seal members which are respectively disposed at opposite end portions of each of the outer rings in the axial direction thereof, respectively. In addition, a ring spacer 20 is interposed between the outer rings 14b and 16b of the roller bearings 14 and 16.

In the embodiment, stainless steel or SUJ steel is applied as the material of each of the inner rings 14a and 16a, the outer rings 14b and 16b, and the balls 14c and 16c. For example, at least one of the inner rings 14a and 16a, the outer rings 14b and 16b, and the balls 14c and 16c is made of alloy steel consisting of, by mass %, C: less than 0.5%, Cr: 8.0% to 20.0%, Mn: 0.1% to 1.5%, Si: 0.1% to 2.0%, and the balance Fe and inevitable impurities. Also, the alloy steel has, on a surface portion thereof, a surface layer containing 0.05 mass % or more of N and less than 0.5 mass % of C, and the N and C contents of the surface layer satisfy a relation of 0.45% (C+N) 1.5% by mass %. Preferably, the C and Cr contents of the alloy steel satisfy a relation of 0.04 Cr %−0.39≦C %≦−0.05 Cr %+1.41 by mass %.

In addition, as other stainless steel, at least one of the inner rings 14a and 16a, the outer rings 14b and 16b, and the balls 14c and 16c is made of alloy steel consisting of, by mass %, C: 0.04% to 0.8%, Si: 1.0% or less, Mn: 1.0% or less, P: 0.1% or less, S: 0.1% or less, Ni: 0.5% or less, Cr: 10.0% to 18.0%, and the balance Fe and inevitable impurities.

Furthermore, as the SUJ steel, at least one of the inner rings 14a and 16a, the outer rings 14b and 16b, and the balls 14c and 16c is made of alloy steel (high carbon chromium bearing steel) consisting of, by mass %, C: 0.95% to 1.10%, Si: 0.15% to 0.35%, Mn: 0.50% or less, P: 0.03% or less, S: 0.03% or less, Cr: 1.20% to 1.65%, and the balance Fe and inevitable impurities.

In the embodiment, it may be possible to decrease a change in torque hysteresis of a swing arm retaining force as time elapses under the drive condition of the HDD and enhance the response characteristics of the swing arm by improving the surface hardness of each member. Specifically, the surface hardness of each of the inner rings 14a and 16a and the outer rings 14b and 16b is 700 HV or more and less than 800 HV, and preferably 720 HV to 780 HV. The surface hardness of each of the balls 14c and 16c is 945 HV or more and less than 1060 HV, and preferably 945 HV to 1050 HV.

As a method of altering the surface hardness of each member, an alteration of steel types, use of a ceramic material, or coating of a surface film material to a member surface as well as an alteration of a material quenching condition or a treatment by shot peening of a rolling element surface can be considered. However, when material physical properties such as a linear expansion coefficient and an elastic modulus are changed, a possibility of affecting HDD performance is increased. Accordingly, an alteration of a surface hardness which does not affect the physical properties was performed on each of the steel types which are currently used.

Here, a simulation test was performed by inserting each pivot bearing unit, which includes the roller bearings (Related Example, Reference Examples 1 to 3, and Examples 1 to 24) having different surface hardness of the respective bearing rings and rolling elements, into the HDD and swinging the same at high speed.

After the test starts, a hysteresis value after one hour has elapsed is assumed as 100% and a change ratio with respect to this hysteresis value is assumed as a decrease ratio of hysteresis. Additionally, the hysteresis value represents a difference due to the directionality of a force required to retain the swing arm when the swing arm fixed to the pivot bearings of the inside of the HDD is displaced from the inner diameter side thereof to the outer diameter side thereof and from the outer diameter side to the inner diameter side, and does not represent a value of the hysteresis itself of the bearing.

The control of the HDD is adversely affected by a large decrease such as the excess of 50% of the decrease ratio of hysteresis. As such, it is preferable that the decrease ratio be low. In the following Table 1, “x” (unacceptable) represents a state where the decrease ratio of hysteresis exceeds 50% after 16 hours, “A” (relatively poor) represents a state where the decrease ratio is in a range of 25% to 50% after 16 hours, “O” (good) represents a state where the decrease ratio is in a range of 10% to 25% after 16 hours, and “00” (excellent) represents a state where the decrease ratio is below 10% after 16 hours. In Conventional Example, Reference Examples 1 to 3, and Examples 1 to 24, the same condition was applied except for the surface hardness of each bearing ring or each rolling element. As grease used for the roller bearings, base oil such as mineral oil and PAO (poly-α-olefin based synthetic oil), and oil containing a urea based viscosity bodying agent were used.

Table 1 represents the surface hardness of each of the bearing rings and the rolling elements, the change ratio of hysteresis after 16 hours, dimension stability, and a total decision which adds both of the change ratio and the dimension stability in Conventional Example, Reference Examples 1 to 3, and Examples 1 to 24.

TABLE 1

| | | Hard- | Change ratio | | |
|---|---|---|---|---|---|
| | Hardness of | ness | of Hysteresis | | |
| | Rolling ring | of Ball | after 16 | Dimension | Total |
| | (HV) | (HV) | hours | stability | decision |
| Conventional | 700 | 920 | X | ◯ | X |
| Example | | | | | |
| Reference | 700 | ≧1060 | Δ | X | X |
| Example 1 | | | | | |
| Reference | ≧800 | 920 | Δ | X | X |
| Example 2 | | | | | |
| Reference | ≧800 | ≧1060 | ◯ | X | X |
| Example 3 | | | | | |
| Example 1 | 700 | 945 | Δ | ◯ | Δ |
| Example 2 | 700 | 1000 | Δ | ◯ | Δ |
| Example 3 | 700 | 1050 | Δ | ◯ | Δ |
| Example 4 | 720 | 920 | Δ | ◯ | Δ |
| Example 5 | 720 | 945 | ◯ | ◯ | ◯ |
| Example 6 | 720 | 960 | ◯ | ◯ | ◯ |
| Example 7 | 720 | 980 | ◯ | ◯ | ◯ |
| Example 8 | 720 | 1000 | ◯ | ◯ | ◯ |
| Example 9 | 720 | 1020 | ◯ | ◯ | ◯ |
| Example 10 | 720 | 1050 | ◯ | ◯ | ◯ |
| Example 11 | 750 | 920 | Δ | ◯ | Δ |
| Example 12 | 750 | 945 | ◯ | ◯ | ◯ |
| Example 13 | 750 | 960 | ◯ | ◯ | ◯ |
| Example 14 | 750 | 980 | ◯ | ◯ | ◯ |
| Example 15 | 750 | 1000 | ◯ | ◯ | ◯ |
| Example 16 | 750 | 1020 | ◯◯ | ◯ | ◯◯ |
| Example 17 | 750 | 1050 | ◯◯ | ◯ | ◯◯ |
| Example 18 | 780 | 920 | Δ | ◯ | Δ |
| Example 19 | 780 | 945 | ◯ | ◯ | ◯ |
| Example 20 | 780 | 960 | ◯ | ◯ | ◯ |
| Example 21 | 780 | 980 | ◯ | ◯ | ◯ |
| Example 22 | 780 | 1000 | ◯◯ | ◯ | ◯◯ |
| Example 23 | 780 | 1020 | ◯◯ | ◯ | ◯◯ |
| Example 24 | 780 | 1050 | ◯◯ | ◯ | ◯◯ |

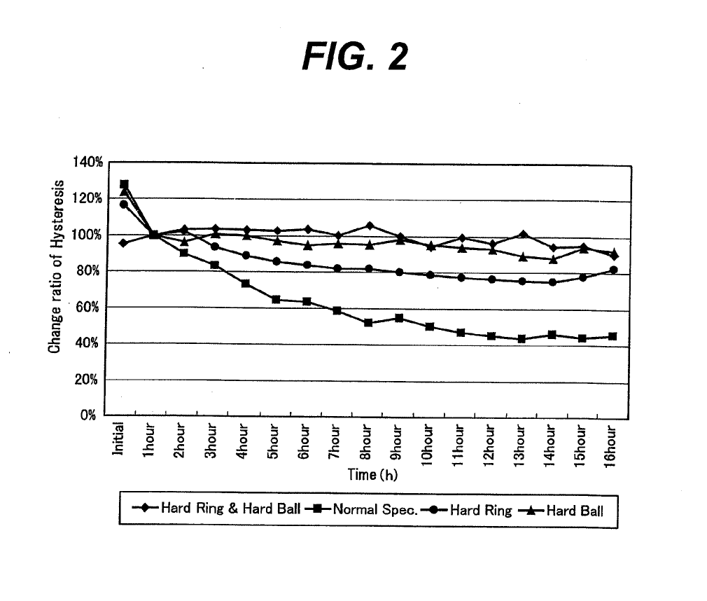

For example, in the standard ball bearing (Related Example) in which the hardness of each of the inner and outer rings is 700 HV and the hardness of the ball is 920 HV, the change ratio of hysteresis with respect to time was large and a decrease ratio thereof exceeded 50%. In addition, in the ball bearing (Example 17) of the present invention in which the hardness of each of the inner and outer rings is 750 HV and the hardness of the ball is 1050 HV, the change ratio of hysteresis with respect to time was very small and a decrease ratio thereof was within 10%. In addition, in the ball bearing (Example 11) of the present invention in which the hardness of each of the inner and outer rings is 750 HV and the hardness of the ball is 920 HV, the change ratio of hysteresis with respect to time was smaller than that of the standard ball bearing and was within 30%. Furthermore, in the ball bearing (Example 3) of the present invention in which the hardness of each of the inner and outer rings is 700 HV and the hardness of the ball is 1050 HV, the change ratio of hysteresis with respect to time was smaller than that of the standard ball bearing and was within 20%. FIG. 2 illustrates the change ratio of hysteresis with respect to time in the Conventional Example (Normal Spec) and Example 3 (Hard Ball), Example 11 (Hard ring), and Example 17 (Hard Ring & Hard Ball).

Accordingly, it was found that the change ratio of hysteresis value, which is obtained by measuring the pivot bearing inserted into the HDD, with respect to time for each of the ring and the ball may be decreased by altering the surface hardness of each of the ring and the ball with respect to a hysteresis. Although the change ratios of the ring and ball may be decreased even when the hardness of any one of the ring and the ball is altered, the change ratio of the ball gives a larger effect than that of the ring. Also, the effect of the change ratio may be significantly increased by altering both of the ring and the ball.

In addition, there is a method of highly altering quenching temperature in order to increase the hardness. However, if the quenching temperature is increased more than necessary, retained austenite (yR) is increased together with the harness and dimension stability is detrimentally affected. Therefore, the upper limit of the hardness was set without affecting other properties of the bearing (see Reference Examples 1 to 3).

In addition, in order to confirm a relationship between the decrease ratio of hysteresis and the absolute value of rotational torque due to the alteration of the hardness, the above-mentioned Conventional Example and Examples 3, 11, and 17 were used or a pre-load with respect to the ball bearing of Example 17 was altered. The result is shown in Table 2.

TABLE 2

| | | | | | Example |
|---|---|---|---|---|---|
| | | | | | 17 |
| | Conventional | Example | | Example | (High |
| | Example | 11 | Example 3 | 17 | Torque) |
| Hardness | 700 | 750 | 700 | 750 | 750 |
| of Inner | | | | | |
| and Outer | | | | | |
| rings (HV) | | | | | |
| Hardness | 920 | 920 | 1050 | 1050 | 1050 |
| of Ball | | | | | |
| (HV) | | | | | |
| Pre-load | 1.46 | 1.46 | 1.46 | 1.46 | 2.56 |
| (lb) | | | | | |
| Torque | 0.31 | 0.42 | 0.35 | 0.40 | 0.70 |
| (gf · cm) | | | | | |
| Decrease | 56.1 | 25.1 | 12.2 | 9.6 | 9.2 |
| ratio of | | | | | |
| Hysteresis | | | | | |
| after | | | | | |
| 16 hours | | | | | |
| (%) | | | | | |

From the result of Table 2, it was found that there is no relationship between the value of rotational torque and the decrease ratio of hysteresis.

Meanwhile, the present invention is not limited to the above-mentioned embodiment and may be properly modified and improved.

For example, the roller bearings 14 and 16 are not limited to the configuration illustrated in the drawings, and may be arbitrarily changed according to the intended purpose or use condition of the HDD or the like. In addition, although the shaft member 12 has a hollow structure which passes through a shaft center portion along the extending direction, the shaft member 12 may also be configured as a solid structure.

This application is based on Japanese Patent Application No. 2011-164758, filed on Jul. 27, 2011 and PCT International Application No. PCT/JP2012/051848, filed on Jan. 27, 2012, the contents of which are incorporated herein by reference.

### EXPLANATION OF REFERENCE NUMERALS

10: pivot bearing unit
14, 16: roller bearing
14a, 16a: inner ring
14b, 16b: outer ring
14c, 16c: ball (rolling element)
14d, 16d: retainer
14e, 16e: non-contact shield
18: sleeve

1. A roller bearing for swinging and rotatably supporting a swing arm provided in a hard disk drive, the bearing comprising:
an inner ring;
an outer ring;
a plurality of rolling elements disposed between the inner ring and the outer ring; and
a retainer that retains the plurality of rolling elements,
wherein the inner ring and the outer ring have a surface hardness of 700 HV or more and less than 800 HV, and each of the rolling elements has a surface hardness of 945 HV or more and less than 1060 HV.

2. The bearing of claim 1, wherein the inner ring and the outer ring have a surface hardness of 720 HV to 780 HV, and each of the rolling elements has a surface hardness of 945 HV to 1050 HV.

3. The bearing of claim 1, wherein each of the inner ring, the outer ring, and the rolling elements is made of any one of stainless steel and SUJ steel.

4. The bearing of claim 2, wherein each of the inner ring, the outer ring, and the rolling elements is made of any of stainless steel and SUJ steel.
